(19) United States
(12) Patent Application Publication
(10) Pub. No.: US 2026/0099986 A1
(43) Pub. Date: Apr. 9, 2026

(54) DATA PROCESSING DEVICE, PROGRAM, STORAGE MEDIUM, AND SERVER

(71) Applicant: SEMICONDUCTOR ENERGY LABORATORY CO., LTD., Atsugi-shi (JP)

(72) Inventors: Jiro IMADA, Atsugi (JP); Naoaki TSUTSUI, Atsugi (JP)

(21) Appl. No.: 19/339,392

(22) Filed: Sep. 25, 2025

(30) Foreign Application Priority Data
Oct. 4, 2024 (JP) 2024-174759

(51) Int. Cl. G06T 15/08; G06T 17/00

(52) U.S. Cl. CPC G06T 15/08; G06T 17/00

(57) ABSTRACT

A novel data processing device that is highly convenient, useful, or reliable is provided. The data processing device includes a memory unit and a processing unit. A program is stored in the memory unit, and the processing unit calculates a vertex normal vector in accordance with the program. The program is composed of five steps. In the first step, a unit region is placed on an object. The unit region has the center of gravity. In the second step, a portion where the unit region and the object overlap is specified. In the third step, the center of gravity of the overlap portion is specified. In the fourth step, a vector from the center of gravity of the overlap portion to a point in the object is specified. In the fifth step, the vector is used as a vertex normal vector at the point in the object.

### BACKGROUND OF THE INVENTION

### 1. Field of the Invention

One embodiment of the present invention relates to a data processing device, a program, a storage medium, a server, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specific examples of the technical field of one embodiment of the present invention disclosed in this specification include a data processing device, a semiconductor device, a memory device, a driving method thereof, and a manufacturing method thereof.

### 2. Description of the Related Art

There is known a method for accurately determining a normal vector by creating a new vertex on a curved element to be approximated, not on each side of triangles, and determining each normal vector (Patent Document 1).

### REFERENCE

[Patent Document 1] Japanese Published Patent Application No. H11-306392

### SUMMARY OF THE INVENTION

An object of one embodiment of the present invention is to provide a novel data processing device that is highly convenient, useful, or reliable. Another object is to provide a novel program that is highly convenient, useful, or reliable. Another object is to provide a novel storage medium that is highly convenient, useful, or reliable. Another object is to provide a novel server that is highly convenient, useful, or reliable. Another object is to provide a novel data processing device, a novel program, a novel storage medium, a novel server, or a novel semiconductor device.

Note that the description of these objects does not preclude the existence of other objects. One embodiment of the present invention does not need to achieve all of these objects. Other objects will be apparent from and can be derived from the description of the specification, the drawings, the claims, and the like.

(1) One embodiment of the present invention is a data processing device including a processing unit and a storage unit.

The processing unit calculates a vertex normal vector in accordance with a program. The storage unit stores the program.

The program includes first to fifth steps.

In the first step, a unit region is placed to overlap with an object. Note that the object is placed in a space, and the unit region has a first center of gravity. The first center of gravity coincides with a point in the object.

In the second step, an overlap portion is specified. Note that the overlap portion corresponds to the object overlapping with the unit region.

In the third step, a second center of gravity of the overlap portion is specified.

In the fourth step, a vector from the second center of gravity to the point is specified.

In the fifth step, the vector is used as the vertex normal vector at the point in the object.

Thus, the vertex normal vector at the point in the object can be easily calculated. As a result, a novel data processing device that is highly convenient, useful, or reliable can be provided.

(2) Another embodiment of the present invention is the above-described data processing device in which the object is formed using a plurality of voxels in the first step. Note that the object includes a first voxel, and the point in the object is a center of gravity of the first voxel.

In the fifth step, the specified vector is used as a vertex normal vector of the first voxel.

(3) Another embodiment of the present invention is the above-described data processing device in which the voxels are cubic and the unit region is composed of voxels of 27 or more and 1000 or less.

Thus, the voxel can be used as a unit of calculation. The calculation load can be reduced. The vertex normal vector can be calculated for each first voxel. With the use of the vertex normal vector, the direction in which light entering from a light source is reflected, for example, can be calculated for each of the first voxels. Even when adjacent first voxels are arranged in a step-like manner, changes in the vertex normal vectors can be smooth. The object can be displayed with rich shading on a display device, for example. As a result, a novel data processing device that is highly convenient, useful, or reliable can be provided.

(4) Another embodiment of the present invention is the above-described data processing device in which the first voxel is in contact with the space in the first step.

Thus, the vertex normal vector of the first voxel positioned on the outermost surface of the object can be calculated. The direction in which the first voxel reflects incident light from a light source, for example, can be calculated using the vertex normal vector. The object can be displayed with rich shading on a display device, for example. As a result, a novel data processing device that is highly convenient, useful, or reliable can be provided.

(5) One embodiment of the present invention is a program including first to ninth steps to be executed by a data processing device.

In the first step, a space and a first object are prepared. Note that the first object is in contact with the space.

In the second step, a second object is formed over the first object. The second object has a first surface in contact with the first object and a second surface in contact with the space, and the second surface faces the first surface. The second object has a flag with a first value or a second value.

In the third step, the procedure proceeds to the fourth step when the flag has the first value, and the procedure proceeds to the fifth step when the flag has the second value.

In the fourth step, a vector that starts from a point on the second surface and is vertical to the second surface is specified, and then the procedure proceeds to the ninth step.

In the fifth step, a unit region is placed to overlap with the second object. Note that the unit region has a first center of gravity, and the first center of gravity coincides with the point in the second object.

In the sixth step, an overlap portion is specified. Note that the overlap portion corresponds to the second object overlapping with the unit region.

In the seventh step, a second center of gravity of the overlap portion is specified.

In the eighth step, the vector from the second center of gravity to the point is specified.

In the ninth step, the vector is used as a vertex normal vector at the point in the second object.

Thus, a method for calculating the vertex normal vector at the point in the second object can be selected in accordance with the flag. For example, in the case where the second object has a step-like shape, vertex normal vectors that change sharply can be employed when the flag has the first value. Vertex normal vectors that change smoothly can be employed when the flag has the second value. The vertex normal vectors that change smoothly can be easily calculated. As a result, a novel program that is highly convenient, useful, or reliable can be provided.

(6) Another embodiment of the present invention is the above-described program in which the first object is formed using a plurality of voxels in the first step.

In the second step, the second object is formed using another plurality of voxels. Note that the second object includes a first voxel in contact with the space.

In the fifth step, the point in the second object is a center of gravity of the first voxel.

In the ninth step, the specified vector is used as a vertex normal vector of the first voxel.

(7) Another embodiment of the present invention is the above-described program in which the voxels are cubic and the unit region is composed of voxels of 27 or more and 1000 or less.

Thus, the voxel can be used as a unit of calculation. The calculation load on the data processing device can be reduced. The vertex normal vector can be calculated for each first voxel. With the use of the vertex normal vector, the direction in which the first voxel reflects incident light from a light source can be calculated, for example. Even when adjacent first voxels are arranged in a step-like manner, changes in the vertex normal vectors can be smooth. The second object can be displayed with rich shading on a display device, for example. As a result, a novel program that is highly convenient, useful, or reliable can be provided.

(8) Another embodiment of the present invention is the above-described program in which in the second step, the second object formed over the first object has a first distance and a second distance between the first surface and the second surface.

Note that the first distance is a distance from part of the first surface in contact with a flat portion of the first object to a closest part of the second surface. The second distance is a distance from part of the first surface in contact with a vertex of the first object to a closest part of the second surface.

The second distance is shorter than the first distance, and a difference between the first distance and the second distance is less than or equal to √3 times a length of one side of the voxel.

Thus, the vertex normal vector of the first voxel positioned on the outermost surface of the second object can be calculated. The direction in which the first voxel reflects incident light from a light source, for example, can be calculated using the vertex normal vector. The second object can be displayed with rich shading on a display device, for example. As a result, a novel program that is highly convenient, useful, or reliable can be provided.

(9) Another embodiment of the present invention is a storage medium that stores the above-described program.

(10) Another embodiment of the present invention is a server that distributes the above-described program.

(11) Another embodiment of the present invention is a server that provides data processing services using the above-described program.

According to one embodiment of the present invention, a novel data processing device that is highly convenient, useful, or reliable can be provided. A novel program that is highly convenient, useful, or reliable can be provided. A novel storage medium that is highly convenient, useful, or reliable can be provided. A novel server that is highly convenient, useful, or reliable can be provided. A novel data processing device, a novel program, a novel storage medium, a novel server, or a novel semiconductor device can be provided.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIGS. 1A and 1B illustrate a structure of a data processing device according to an embodiment;

FIGS. 2A and 2B are diagrams for explaining a data processing device according to an embodiment;

FIGS. 3A and 3B are diagrams for explaining a data processing device according to an embodiment;

FIGS. 4A and 4B are diagrams for explaining a data processing device according to an embodiment;

FIG. 5 illustrates a structure of a program according to an embodiment;

FIGS. 6A and 6B are diagrams for explaining a program according to an embodiment;

FIGS. 7A and 7B are diagrams for explaining a program according to an embodiment;

FIGS. 8A and 8B are diagrams for explaining a program according to an embodiment;

FIGS. 9A and 9B are diagrams for explaining a program according to an embodiment;

FIGS. 10A and 10B are diagrams for explaining a program according to an embodiment;

FIGS. 11A and 11B are diagrams for explaining a program according to an embodiment; and

FIGS. 12A and 12B are diagrams for explaining a program according to an embodiment.

### DETAILED DESCRIPTION OF THE INVENTION

A data processing device of one embodiment of the present invention includes a processing unit and a storage unit. The processing unit calculates a vertex normal vector in accordance with a program. The storage unit stores the program. The program includes first to fifth steps. In the first step, a unit region is placed to overlap with an object. Note that the object is placed in a space, the unit region has a first center of gravity, and the first center of gravity coincides with a point in the object. In the second step, an overlap portion is specified. The overlap portion corresponds to the object overlapping with the unit region. In the third step, a second center of gravity of the overlap portion is specified. In the fourth step, a vector from the second center of gravity to the point is specified. In the fifth step, the vector is used as the vertex normal vector at the point in the object.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be provided with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

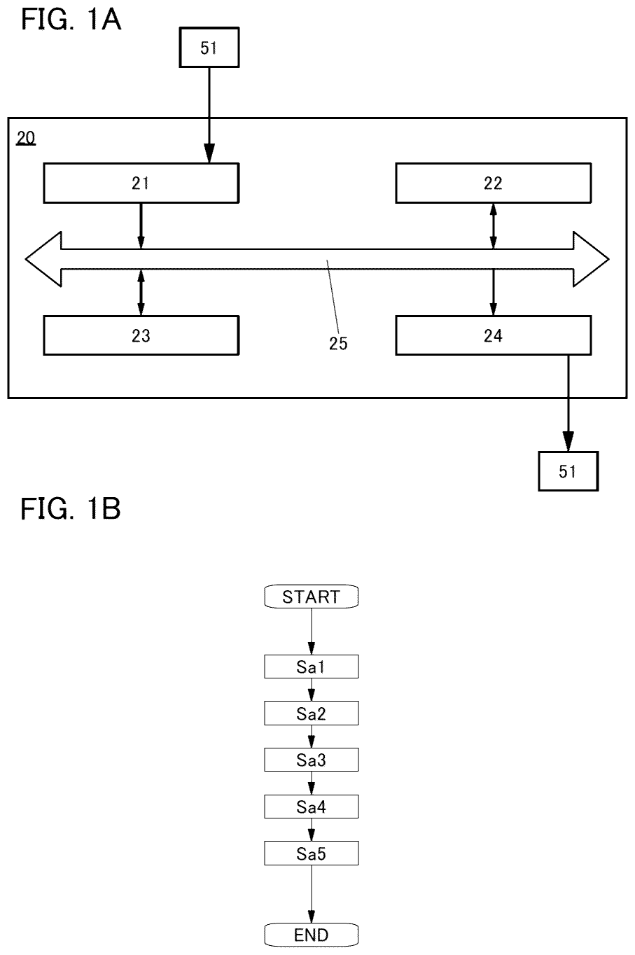

In this embodiment, a data processing device of one embodiment of the present invention will be described with reference to FIGS. 1A and 1B, FIGS. 2A and 2B, FIGS. 3A and 3B, and FIGS. 4A and 4B.

FIG. 1A illustrates a structure of the data processing device of one embodiment of the present invention, and FIG. 1B illustrates a program executed by the data processing device of one embodiment of the present invention.

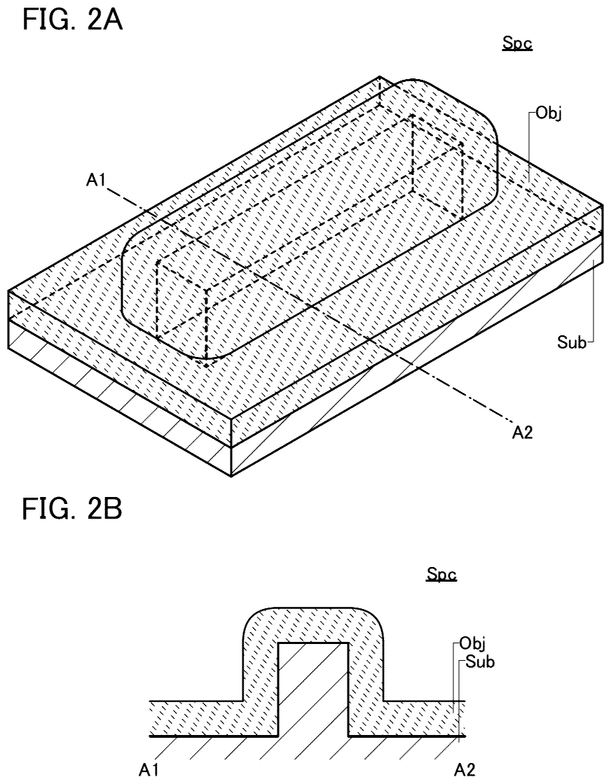

FIG. 2A is a perspective view of a three-dimensional model used for explaining the data processing device of one embodiment of the present invention, and FIG. 2B is a cross-sectional view along the cutting line A1-A2 in FIG. 2A.

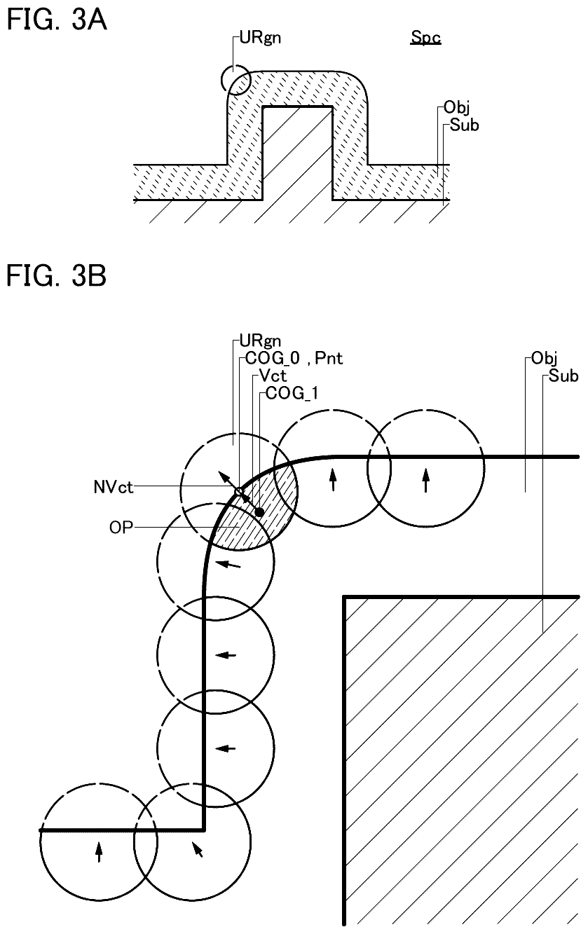

FIG. 3A is a cross-sectional view of the three-dimensional model used for explaining the data processing device of one embodiment of the present invention, and FIG. 3B is a cross-sectional view illustrating part of FIG. 3A.

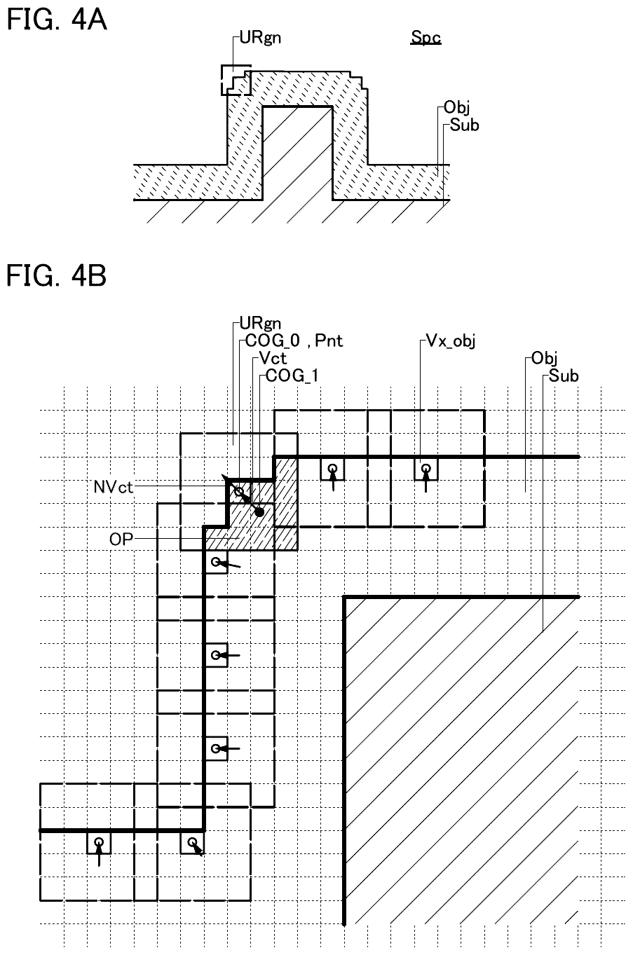

FIG. 4A is a cross-sectional view of the three-dimensional model used for explaining the data processing device of one embodiment of the present invention, and FIG. 4B is a cross-sectional view illustrating part of FIG. 4A.

### Structure Example 1 of Data Processing Device

A data processing device 20 of one embodiment of the present invention includes a processing unit 23 and a storage unit 22 (see FIG. 1A).

The processing unit 23 calculates a vertex normal vector NVct in accordance with a program Prg.

The memory unit 22 stores the program Prg.

### Example of Program Prg

The program Prg includes Step Sa1 to Step Sa5 (see FIG. 1B).

For example, when the data processing device displays a three-dimensional model on a display portion, the data processing device calculates the direction of light reflected by the three-dimensional model and uses the calculated direction for display. Note that the data processing device calculates the direction of light reflected by the three-dimensional model with the use of the positional information of a light source and a normal vector of the three-dimensional model.

A normal vector changes greatly in the vicinity of a vertex of the three-dimensional model. Therefore, data that records changes in normal vectors in the vicinity of a vertex of the three-dimensional model is particularly important, and a program that enables the data processing device to calculate a normal vector with a small load is desired. Note that in this specification, a normal vector in the vicinity of a vertex of a three-dimensional model is referred to as a vertex normal vector.

FIG. 2A illustrates a three-dimensional model used for explaining the data processing device of one embodiment of the present invention. FIG. 2B illustrates a cross-sectional structure of the three-dimensional model along the cutting line A1-A2 in FIG. 2A.

The three-dimensional model includes an object Obj and an object Sub, for example. The object Obj is placed over the object Sub.

### Example 1 of Step Sa1

In Step Sa1, a unit region URgn is placed to overlap with the object Obj (see FIG. 1B and FIG. 3A). Note that the object Obj is placed in a space Spc. For example, a spherical region or a region surrounded by a polyhedron such as a cube or an octahedron can be used as the unit region URgn.

The unit region URgn has a center of gravity COG_0 (see FIG. 3B). The center of gravity COG_0 is placed to coincide with a given point Pnt in the object Obj.

### Step Sa2

In Step Sa2, an overlap portion OP is specified (see FIG. 1B and FIG. 3B). Note that the overlap portion OP corresponds to the object Obj overlapping with the unit region URgn.

### Step Sa3

In Step Sa3, a center of gravity COG_1 of the overlap portion OP is specified (see FIG. 1B and FIG. 3B).

### Step Sa4

In Step Sa4, a vector Vct from the center of gravity COG_1 to the point Pnt is specified (see FIG. 1B and FIG. 3B). Note that FIG. 3B illustrates a plurality of unit regions each including a portion overlapping with the object Obj. The above-described vectors are specified in the respective unit regions and indicated by arrows. As shown in the diagram, these vectors change their directions smoothly in accordance with the positions of the unit regions.

### Example 1 of Step Sa5

In Step Sa5, the vector Vct is used as the vertex normal vector NVct at the point Pnt in the object Obj (see FIG. 1B and FIG. 3B).

Thus, the vertex normal vector NVct at the point Pnt in the object Obj can be easily calculated. As a result, a novel data processing device that is highly convenient, useful, or reliable can be provided.

### Example 2 of Step Sa1

In Step Sa1, the object Obj can be formed using a plurality of voxels Vx having the same shape (see FIGS. 4A and 4B). Note that the voxel Vx is, for example, a three-dimensional element and can be used as a unit for a three-dimensional model. When the voxel Vx is used as the unit for a three-dimensional model, the three-dimensional model can be expressed using discrete coordinates. Moreover, the calculation load can be reduced.

For example, the shape of the voxel Vx can be a cube. With the use of cubic voxels Vx, the three-dimensional model illustrated in FIGS. 3A and 3B can be expressed as in FIGS. 4A and 4B, for example. Moreover, with the use of the cubic voxels Vx, a curved surface of the three-dimensional model is expressed with a step-like shape.

The object Obj includes a voxel Vx_obj. In other words, the voxel Vx_obj is a given one of the plurality of voxels Vx constituting the object Obj. A point representing the voxel Vx_obj is set in each voxel Vx_obj. The above-described point Pnt is selected from the points representing the voxels Vx_obj. For example, the center of gravity of the voxel Vx_obj can be used as the point Pnt.

The unit region URgn can be composed of voxels Vx of 27 or more and 1000 or less. For example, in the case where the voxel Vx is three-dimensional, the unit region URgn can be a region that is composed of a total of 27 voxels Vx by arranging three voxels Vx in the vertical direction, three voxels Vx in the horizontal direction, and three voxels Vx in the height direction. Alternatively, the unit region URgn can be a region that is composed of a total of 1000 voxels Vx by arranging 10 voxels Vx in the vertical direction, 10 voxels Vx in the horizontal direction, and 10 voxels Vx in the height direction.

Note that a plurality of unit regions are illustrated as rectangles in FIG. 4B. Each of the unit regions includes a portion overlapping with the object Obj. In each of the unit regions, the above-described vector from the center of gravity COG_1 to the point Pnt is specified and indicated by an arrow. As shown in the diagram, even in the portion expressed with a step-like shape, these vectors change their directions smoothly in accordance with the positions of the unit regions. In other words, the vectors change smoothly even in a three-dimensional model expressed using discrete coordinates. Furthermore, the vector can be used as the vertex normal vector.

### Example 2 of Step Sa5

In Step Sa5, the vector Vct is used as the vertex normal vector NVct of the voxel Vx_obj. Note that the vertex normal vector is defined at each vertex of the voxel. For example, when the voxel is a cube (hexahedron), 24 vectors can be defined. The data processing device of one embodiment of the present invention employs the same vector as the vertex normal vectors defined at the vertices of the voxel. In other words, the vector Vct can be used as the vertex normal vectors at the vertices of the voxel Vx_obj.

Thus, the voxel Vx can be used as a unit of calculation. The calculation load can be reduced. The vertex normal vector NVct can be calculated for each of the voxels Vx_obj. With the use of the vertex normal vector NVct, the direction in which light entering from a light source is reflected, for example, can be calculated for each of the voxels Vx_obj. Even when adjacent voxels Vx_obj are arranged in a step-like manner, changes in the vertex normal vectors NVct can be smooth. The object Obj can be displayed with rich shading on a display device, for example. As a result, a novel data processing device that is highly convenient, useful, or reliable can be provided.

### Example 3 of Step Sa1

In Step Sa1, a voxel Vx in contact with the space Spc can be selected and used as the voxel Vx_obj (see FIG. 4B). Note that in the case where the object Obj reflects light on the surface, the voxel Vx in contact with the space Spc determines the direction in which the object Obj reflects light.

Thus, the vertex normal vector NVct of the voxel Vx_obj positioned on the outermost surface of the object Obj can be calculated. The direction in which the voxel Vx_obj reflects incident light from a light source, for example, can be calculated using the vertex normal vector NVct. The object Obj can be displayed with rich shading on a display device, for example. As a result, a novel data processing device that is highly convenient, useful, or reliable can be provided.

### Structure Example 2 of Data Processing Device

The data processing device 20 that can be used for a data processing system of one embodiment of the present invention includes, for example, an input unit 21, the storage unit 22, the processing unit 23, an output unit 24, and a transmission path 25 (see FIG. 1A).

Although a block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed by the processing unit 23 may be executed in different data processing devices depending on processing content.

### Input Unit 21

The input unit 21 can receive data from the outside of the data processing device. For example, the input unit 21 receives data via a network 51. Specifically, a device such as a personal computer having a communication port or a communication function can be used.

The input unit 21 supplies the received data to one or both of the storage unit 22 and the processing unit 23 via the transmission path 25.

### Storage Unit 22

The storage unit 22 has a function of storing a program to be executed by the processing unit 23. The storage unit 22 can also have a function of storing data generated by the processing unit 23 (e.g., an arithmetic operation result, an analysis result, and an inference result), data received by the input unit 21, and the like.

The storage unit 22 can include a database. The data processing device can include a database in addition to the storage unit 22. The data processing device can have a function of extracting data from a database outside the storage unit 22, the data processing device, or the data processing system. The data processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistors include a metal oxide in their channel formation regions (such transistors are also referred to as OS transistors). An OS transistor has an extremely low current that flows between a source and a drain in an off state, that is, an extremely low leakage current. The NOSRAM can be used as a nonvolatile memory by retaining electric charge corresponding to data in memory cells with the use of the characteristics of extremely low leakage current. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or indium gallium zinc oxide (In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that two or more of the above elements can be used in combination as the element M in some cases. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide or gallium tin oxide).

### Processing Unit 23

The processing unit 23 has a function of performing processing such as arithmetic operation, analysis, and inference with the use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit (or neural network processing unit: NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like that are stored in the storage unit 22 are loaded into the RAM for execution. The data, program, and program module that are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultraviolet erasable programmable read only memory (UV-EPROM) that can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the data processing system can be reduced.

The data processing device preferably uses AI for at least part of its processing.

In particular, the data processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### Output Unit 24

The output unit 24 can output at least one of an arithmetic operation result, an analysis result, and an inference result in the processing unit 23 to the outside of the data processing device. For example, the output unit 24 can transmit data via the network 51. Specifically, a device such as a personal computer having a communication port or a communication function can be used. Furthermore, a device having a communication function may be used as the input unit 21 and the output unit 24.

### Transmission Path 25

The transmission path 25 has a function of transmitting data. Data transmission and reception between the input unit 21, the storage unit 22, the processing unit 23, and the output unit 24 can be performed via the transmission path 25.

Note that this embodiment can be combined with the other embodiment in this specification as appropriate.

### EMBODIMENT 2

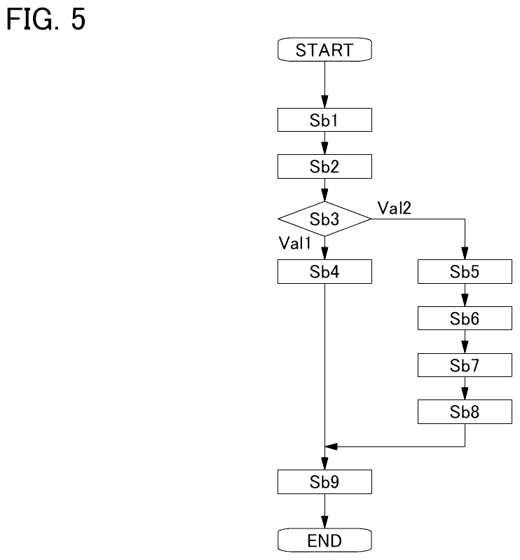

In this embodiment, a program of one embodiment of the present invention will be described with reference to FIG. 5 to FIG. 12B.

FIG. 5 illustrate the program of one embodiment of the present invention.

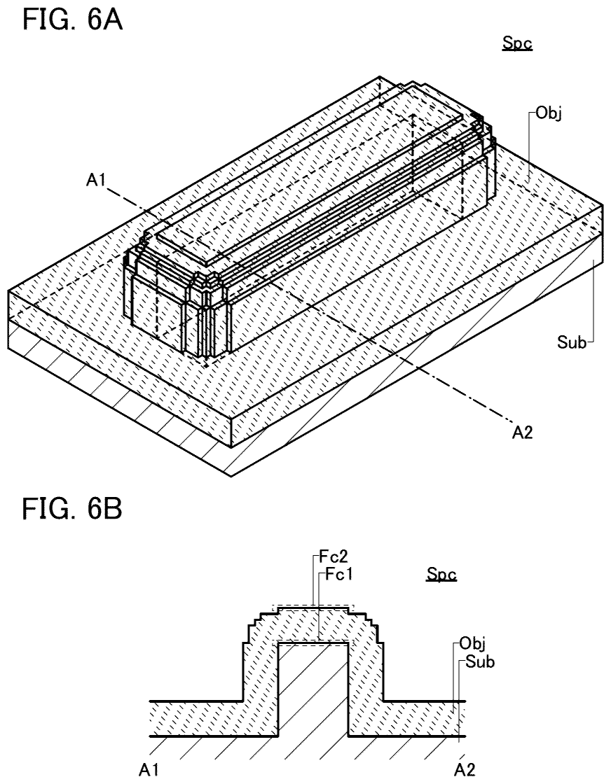

FIG. 6A is a perspective view of a three-dimensional model used for explaining the operation of the program of one embodiment of the present invention, and FIG. 6B is a cross-sectional view along the cutting line A1-A2 in FIG. 6A.

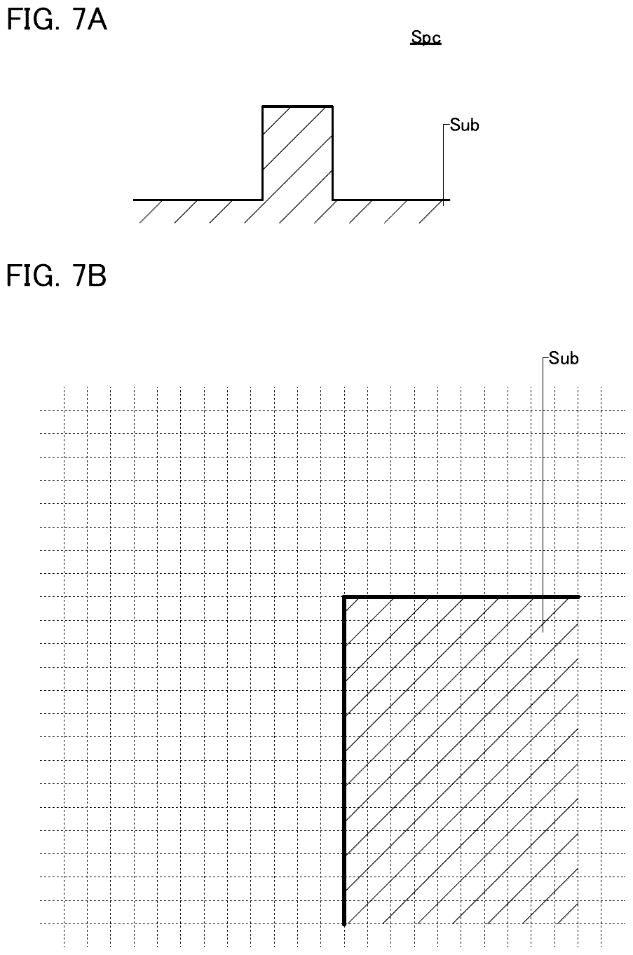

FIG. 7A is a cross-sectional view for explaining the operation of the program of one embodiment of the present invention, and FIG. 7B is a cross-sectional view illustrating part of FIG. 7A.

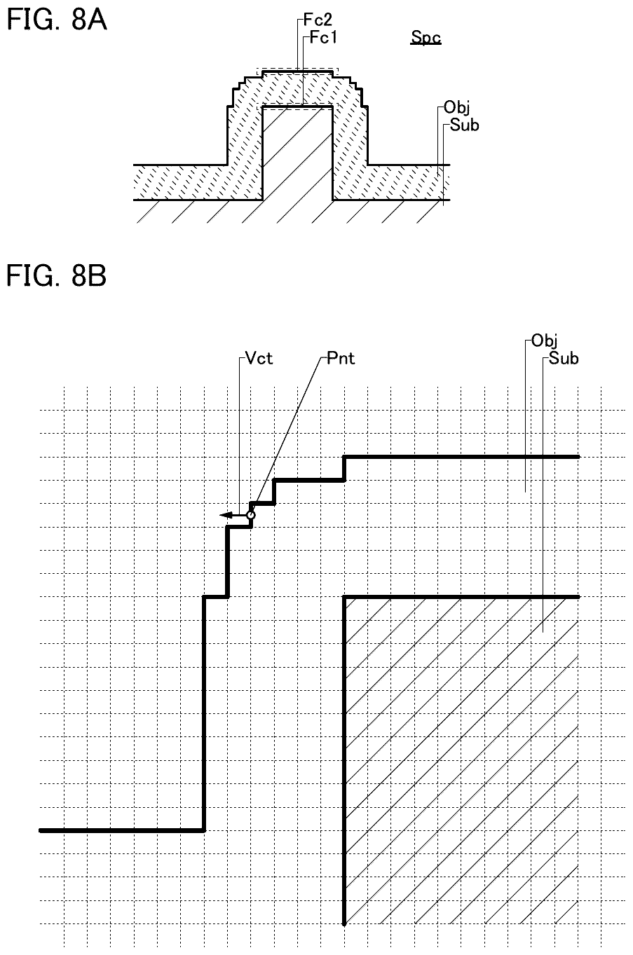

FIG. 8A is a cross-sectional view for explaining the operation of the program of one embodiment of the present invention, and FIG. 8B is a cross-sectional view illustrating part of FIG. 8A.

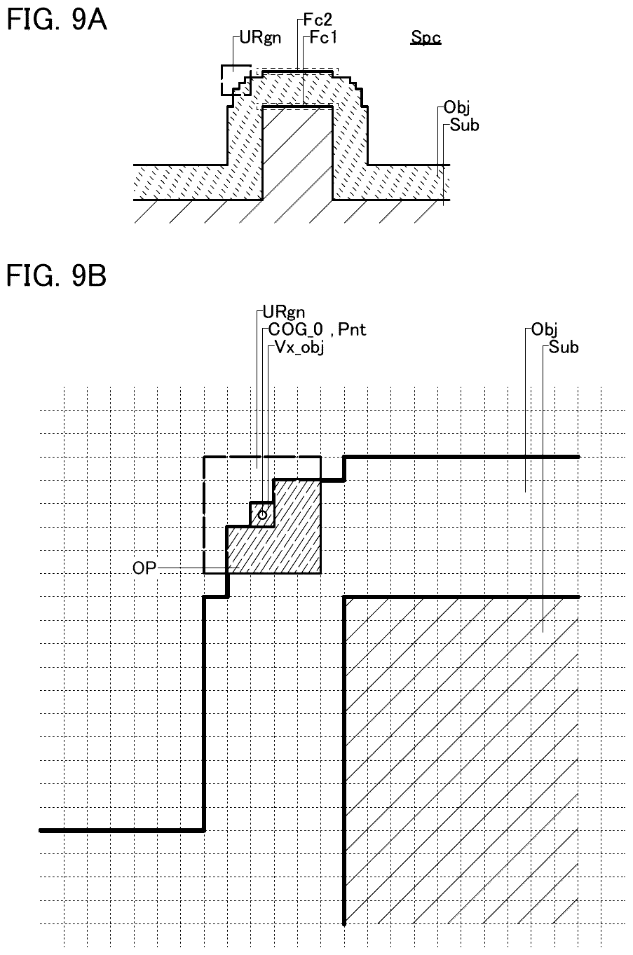

FIG. 9A is a cross-sectional view for explaining the operation of the program of one embodiment of the present invention, and FIG. 9B is a cross-sectional view illustrating part of FIG. 9A.

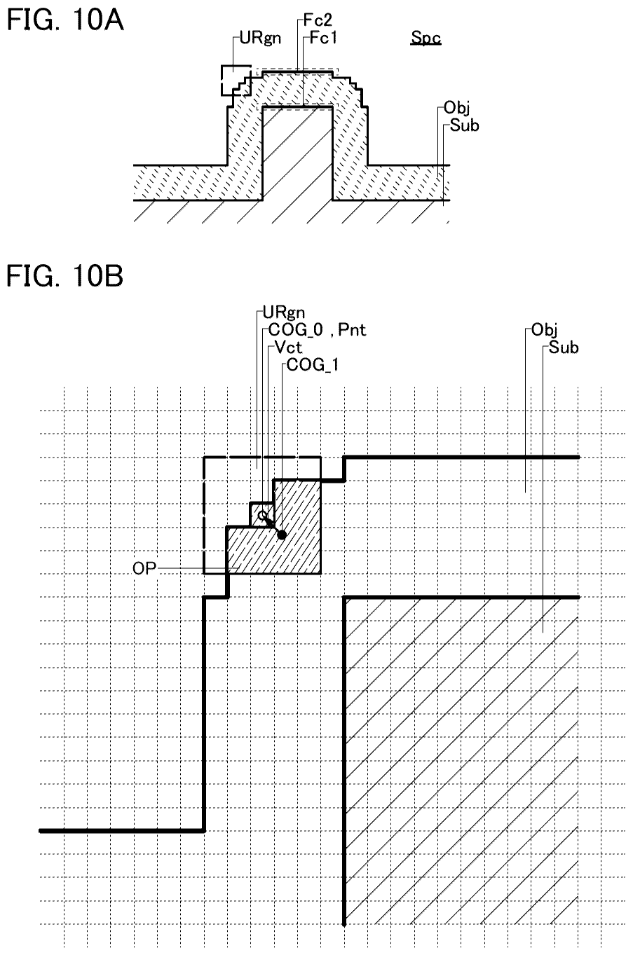

FIG. 10A is a cross-sectional view for explaining the operation of the program of one embodiment of the present invention, and FIG. 10B is a cross-sectional view illustrating part of FIG. 10A.

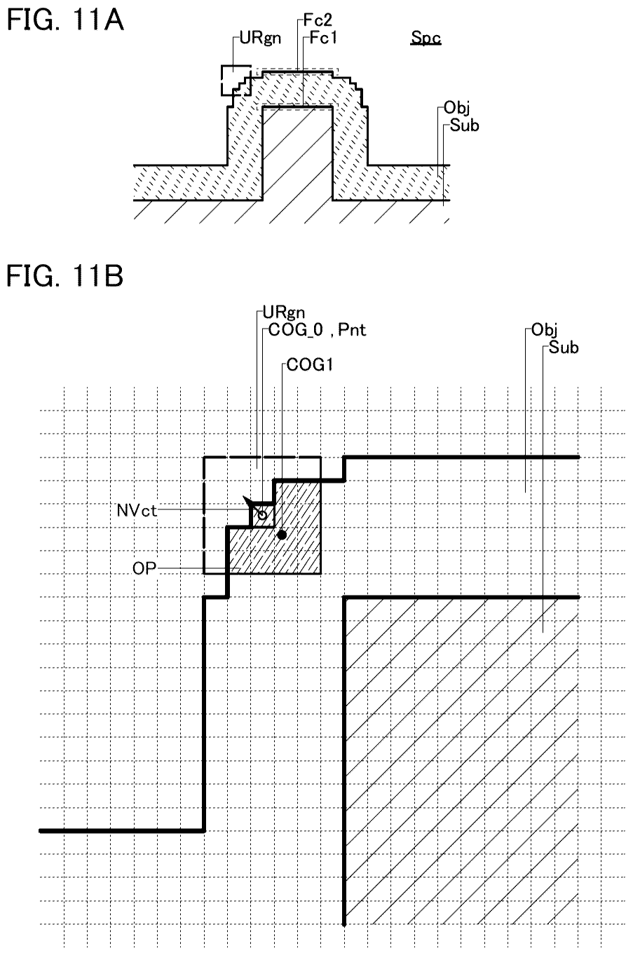

FIG. 11A is a cross-sectional view for explaining the operation of the program of one embodiment of the present invention, and FIG. 11B is a cross-sectional view illustrating part of FIG. 11A.

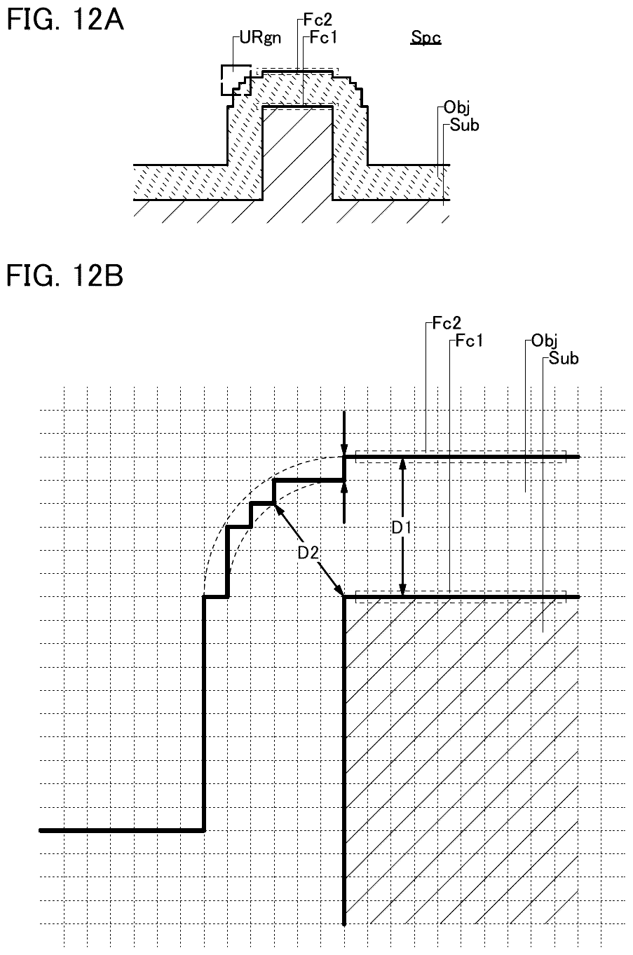

FIG. 12A is a cross-sectional view for explaining the operation of the program of one embodiment of the present invention, and FIG. 12B is a cross-sectional view illustrating part of FIG. 12A.

### Example 1 of Program for Calculating Vertex Normal Vector

FIG. 6A illustrates a three-dimensional model used for explaining the operation of the program of one embodiment of the present invention. FIG. 6B illustrates a cross-sectional structure of the three-dimensional model along the cutting line A1-A2 in FIG. 6A.

The program of one embodiment of the present invention makes the data processing device execute Step Sb1 to Step Sb9 (see FIG. 5).

### Example 1 of Step Sb1

In Step Sb1, the space Spc and the object Sub are prepared (see FIG. 5 and FIGS. 7A and 7B). Note that the object Sub is in contact with the space Spc. Although FIGS. 7A and 7B illustrate the object Sub composed of the voxels Vx as an example, one embodiment of the present invention is not limited thereto.

### Example 1 of Step Sb2

In Step Sb2, the object Obj is formed over the object Sub (see FIG. 5 and FIGS. 8A and 8B). Although FIG. 8A and FIG. 8B illustrate the object Obj composed of the voxels Vx as an example, one embodiment of the present invention is not limited thereto.

Note that the object Obj includes a surface Fc1 in contact with the object Sub and a surface Fc2 in contact with the space Spc, and the surface Fc2 faces the surface Fc1. The object Obj has a flag Flg with a value Val1 or a value Val2. For example, the user of the program of one embodiment of the present invention can set the value of the flag Flg. Specifically, the value of the flag Flg can be set by inputting the value Val1 or the value Val2 to the data processing device at the time of forming the object Obj over the object Sub.

For example, when the flag Flg has the value Val1, a method for calculating a vertex normal vector of one embodiment of the present invention is not used for the object Obj. In other words, vectors that change sharply in the vicinity of a vertex are used as normal vectors of the object Obj.

When the flag Flg has the value Val2, the method for calculating a vertex normal vector of one embodiment of the present invention is used for the object Obj. In other words, vectors that change smoothly in the vicinity of the vertex are used as normal vectors of the object Obj.

### Step Sb3

When the flag Flg has the value Val1 in Step Sb3, the procedure proceeds to Step Sb4 (see FIG. 5). When the flag Flg has the value Val2, the procedure proceeds to Step Sb5.

### Step Sb4

In Step Sb4, a vector Vct that starts from the point Pnt on the surface Fc2 and is vertical to the surface Fc2 is specified, and then the procedure proceeds to Step Sb9 (see FIG. 5 and FIG. 8B). Accordingly, the normal vector of the object Obj changes sharply in the vicinity of the vertex.

### Example 1 of Step Sb5

In Step Sb5, the unit region URgn is placed to overlap with the object Obj (see FIG. 5 and FIG. 9A). Note that the unit region URgn has the center of gravity COG_0, and the center of gravity COG_0 overlaps with the point Pnt in the object Obj (see FIG. 9B).

### Step Sb6

In Step Sb6, the overlap portion OP is specified. The overlap portion OP corresponds to the object Obj overlapping with the unit region URgn.

### Step Sb7

In Step Sb7, the center of gravity COG_1 of the overlap portion OP is specified (see FIG. 5 and FIG. 10B).

### Step Sb8

In Step Sb8, the vector Vct from the center of gravity COG_1 to the point Pnt is specified. When the center of gravity COG_1 and the point Pnt match, the vector Vct is a zero vector. In the case where the vector Vct is a zero vector, the procedure proceeds to Step Sb4, for example. In addition, a unit vector that is vertical to the surface Fc2 at the closest position can be specified and used as the vector Vct.

### Example 1 of Step Sb9

In Step Sb9, the vector Vct is used as the vertex normal vector NVct at the point Pnt in the object Obj (see FIG. 5 and FIG. 11B). Moreover, the vector Vct is used as the vertex normal vector NVct of the voxel Vx_obj.

Thus, a method for calculating the vertex normal vector NVct at the point Pnt in the object Obj can be selected in accordance with the flag Flg. For example, in the case where the object Obj has a step-like shape, the vertex normal vector NVct that changes sharply can be employed when the flag Flg has the value Val1. The vertex normal vector NVct that changes smoothly can be employed when the flag Flg has the value Val2. In addition, the vertex normal vector NVct that changes smoothly can be easily calculated. Accordingly, a novel program that is highly convenient, useful, or reliable can be provided.

### Example 2 of Program for Calculating Vertex Normal Vector

In the program of one embodiment of the present invention, the voxel Vx can be used as a unit for the three-dimensional model. Here, portions different from the above-described steps of the program will be described in detail, and the above description is referred to for the same portions.

### Example 2 of Step Sb1

In Step Sb1, the object Sub is formed using a plurality of the voxels Vx (see FIG. 5 and FIGS. 7A and 7B).

### Example 2 of Step Sb2

In Step Sb2, the object Obj is formed using a plurality of the voxels Vx (see FIG. 5 and FIGS. 8A and 8B). Note that the object Obj includes the voxel Vx_obj in contact with the space Spc.

### Example 2 of Step Sb5

In Step Sb5, the point Pnt is the center of gravity of the voxel Vx_obj (see FIG. 5 and FIG. 9B). Note that the voxel Vx has a cubic shape.

### Example 2 of Step Sb9

In Step Sb9, the vector Vct is used as the vertex normal vector NVct of the voxel Vx_obj.

The unit region URgn is composed of voxels Vx of 27 or more and 1000 or less.

Thus, the voxel Vx can be used as a unit of calculation. The calculation load on the data processing device can be reduced. The vertex normal vector NVct can be calculated for each of the voxels Vx_obj. With the use of the vertex normal vector NVct, the direction in which the voxel Vx_obj reflects incident light from a light source can be calculated, for example. Even when adjacent voxels Vx_obj are arranged in a step-like manner, changes in the vertex normal vectors NVct can be smooth. The object Obj can be displayed with rich shading on a display device, for example. Accordingly, a novel program that is highly convenient, useful, or reliable can be provided.

### Example 3 of Program for Calculating Vertex Normal Vector

In the program of one embodiment of the present invention, the shape of the object Obj formed over the object Sub is influenced by the shape of the object Sub serving as a base. Here, portions different from the above-described steps of the program will be described in detail, and the above description is referred to for the same portions. Note that a semiconductor device has a structure in which a plurality of layers are stacked. For example, processing steps for a semiconductor device can be simulated and reproduced using the program of one embodiment of the present invention. Moreover, a three-dimensional model of a semiconductor device can be created using the program of one embodiment of the present invention.

### Example 3 of Step Sb2

In Step Sb2, the object Obj formed over the object Sub has a distance D1 and a distance D2 between the surface Fc1 and the surface Fc2 (see FIG. 5 and FIGS. 12A and 12B).

Note that the distance D1 is a distance from part of the surface Fc1 in contact with a flat portion of the object Sub to the closest part of the surface Fc2. The distance D2 is a distance from part of the surface Fc1 in contact with the vertex of the object Sub to the closest part of the surface Fc2. The distance D2 is shorter than the distance D1, and the difference between the distance D1 and the distance D2 is less than or equal to √3 times the length of one side of the voxel Vx. In other words, the voxels Vx are placed such that the difference between the distance D1 and the distance D2 is less than or equal to √3 times the length of one side of the voxel Vx. Note that when the voxel Vx has a cubic shape, the length of one side of the voxel Vx multiplied by √3 is equal to the diagonal length of the voxel Vx. The voxels Vx constituting the object Sub can be arranged by a fast marching method, for example.

Thus, the vertex normal vector NVct of the voxel Vx_obj positioned on the outermost surface of the object Obj can be calculated. The direction in which the voxel Vx_obj reflects incident light from a light source, for example, can be calculated using the vertex normal vector NVct. The object Obj can be displayed with rich shading on a display device, for example. Accordingly, a novel program that is highly convenient, useful, or reliable can be provided.

Note that the program of one embodiment of the present invention can be distributed by being stored in a variety of storage media. For example, the program of one embodiment of the present invention can be distributed by being stored in an optical disk, a read-only memory, or a flash memory.

The program of one embodiment of the present invention can be distributed using a server.

Data processing services using the program of one embodiment of the present invention can be provided with the use of a server.

Note that this embodiment can be combined with the other embodiment in this specification as appropriate.

This application is based on Japanese Patent Application Serial No. 2024-174759 filed with Japan Patent Office on Oct. 4, 2024, the entire contents of which are hereby incorporated by reference.

What is claimed is:

1. A data processing device comprising:
a processing unit; and
a storage unit,
wherein the processing unit calculates a vertex normal vector in accordance with a program,
wherein the storage unit stores the program,
wherein the program comprises a first step, a second step, a third step, a fourth step, and a fifth step,
wherein in the first step, a unit region is placed to overlap with an object,
wherein the object is placed in a space,
wherein the unit region comprises a first center of gravity,
wherein the first center of gravity coincides with a point in the object,
wherein in the second step, an overlap portion where the object overlaps with the unit region is specified,
wherein in the third step, a second center of gravity of the overlap portion is specified,
wherein in the fourth step, a vector from the second center of gravity to the point in the object is specified, and
wherein in the fifth step, the vector is used as the vertex normal vector at the point in the object.

2. The data processing device according to claim 1,
wherein in the first step, the object is formed using a plurality of voxels,
wherein the object comprises a first voxel,
wherein the point is a center of gravity of the first voxel, and
wherein in the fifth step, the vector is used as a vertex normal vector of the first voxel.

3. The data processing device according to claim 2,
wherein the voxels are cubic, and
wherein the unit region is composed of voxels of 27 or more and 1000 or less.

4. The data processing device according to claim 2,
wherein in the first step, the first voxel is in contact with the space.

5. A non-transitory computer-readable storage medium storing a program which, when executed by a data processing device, causes a data processing system to perform a method comprising:
a first step, a second step, a third step, a fourth step, a fifth step, a sixth step, a seventh step, an eighth step, and a ninth step,
wherein in the first step, a space and a first object are prepared,
wherein the first object is in contact with the space,
wherein in the second step, a second object is formed over the first object,
wherein the second object comprises a first surface in contact with the first object and a second surface in contact with the space,
wherein the second surface faces the first surface,
wherein the second object comprises a flag comprising a first value or a second value,
wherein in the third step, a procedure proceeds to the fourth step when the flag comprises the first value, and the procedure proceeds to the fifth step when the flag comprises the second value,
wherein in the fourth step, a vector that starts from a point on the second surface and is vertical to the second surface is specified, and then the procedure proceeds to the ninth step,
wherein in the fifth step, a unit region is placed to overlap with the second object,
wherein the unit region comprises a first center of gravity,
wherein the first center of gravity coincides with the point in the second object,
wherein in the sixth step, an overlap portion where the second object overlaps with the unit region is specified,
wherein in the seventh step, a second center of gravity of the overlap portion is specified,
wherein in the eighth step, the vector from the second center of gravity to the point is specified, and
wherein in the ninth step, the vector is used as a vertex normal vector at the point in the second object.

6. The non-transitory computer-readable storage medium storing a program which, when executed by a data processing device, causes a data processing system to perform a method according to claim 5,
wherein in the first step, the first object is formed using a first plurality of voxels,
wherein in the second step, the second object is formed using a second plurality of voxels,
wherein the second object comprises a first voxel in contact with the space,
wherein in the fifth step, the point is a center of gravity of the first voxel, and
wherein in the ninth step, the vector is used as a vertex normal vector of the first voxel.

7. The non-transitory computer-readable storage medium storing a program which, when executed by a data processing device, causes a data processing system to perform a method according to claim 6,
wherein the voxels are cubic, and
wherein the unit region is composed of voxels of 27 or more and 1000 or less.

8. The non-transitory computer-readable storage medium storing a program which, when executed by a data processing device, causes a processing system to perform a method according to claim 7,
wherein in the second step, the second object formed over the first object comprises a first distance and a second distance between the first surface and the second surface,
wherein the first distance is a distance from part of the first surface in contact with a flat portion of the first object to a closest part of the second surface,
wherein the second distance is a distance from part of the first surface in contact with a vertex of the first object to a closest part of the second surface,
wherein the second distance is shorter than the first distance, and
wherein a difference between the first distance and the second distance is less than or equal to √3 times a length of one side of the voxel.

9. A server comprising the non-transitory computer-readable storage medium storing a program according to claim 5, wherein the server distributes the program.

10. A server comprising the non-transitory computer-readable storage medium storing a program according to claim 5, wherein the server provides data processing services using the program.
